(19) United States
(12) Patent Application Publication
(10) Pub. No.: US 2007/0160809 A1
(43) Pub. Date: Jul. 12, 2007

(54) Air freshener decal

(76) Inventors: Robert Juran, Independence, OH (US); Craig M. Saunders, Rocky River, OH (US); Trevor L. Jackson, Kirtland, OH (US)

Correspondence Address: FAY SHARPE LLP, 1100 SUPERIOR AVENUE, SEVENTH FLOOR, CLEVELAND, OH, 44114, US

(21) Appl. No.: 11/451,713

(22) Filed: Jun. 13, 2006

Related U.S. Application Data
(63) Continuation-in-part of application No. 10/750,286, filed on Dec. 31, 2003, now abandoned.
(60) Provisional application No. 60/437,476, filed on Jan. 2, 2003.

(51) Int. Cl. B32B 3/10

(52) U.S. Cl. 428/138; 422/125

(57) ABSTRACT

An unobtrusive air freshener is planar in nature and can resemble a parking or membership sticker. The air freshener can comprise a fragrance carrying polymer, a graphic sheet, and a static cling polymer layer. The static cling polymer layer can be adhesive free and adapted to adhere to a substantially flat surface without leaving a residue.

This application is a continuation-in-part and claims priority of utility application Ser. No. 10/750,286, filed Dec. 31, 2003, which in turn claims priority of provisional application Ser. No. 60/437,476, filed Jan. 2, 2003.

### BACKGROUND

This invention. relates substantially to air fresheners which release a scent or absorb a scent in a confined space and more particularly to a thin planar air freshener which can be applied to a substantially flat surface (i.e. glass, metal, plastic, etc.).

Confined spaces often develop an odor which can be less than pleasant. Kitchens, bathrooms, automobile interiors, lockers and other spaces often suffer from odor problems. In the past, people have addressed these odor problems by positioning air fresheners which release a scent into these spaces. Another approach has been taken with smaller spaces such as closed lockers or refrigerators. Refrigerators and lockers, for example, sometimes develop an odor based upon some of the food ingredients or gear stored therein. One remedy used with refrigerators is the positioning of an opened box of baking soda in the refrigerator, the thought being that the baking soda absorbs the offensive odor.

Prior approaches have shortcomings. An easily visible air freshener, in some situations, can be viewed as a statement that there is an odor problem in the space involved. Moreover, some air fresheners have a less than pleasing appearance to many people. Particularly in an automobile or locker setting, an air freshener needs to be retained in place because of the motion of the automobile (or a door of a locker) and replaceable when exhausted. These requirements and the requirement for a pleasing appearance are somewhat contradictory.

### SUMMARY

The present invention provides an air freshener which is planar and unobtrusive resembling, for example, a parking or club membership decal and which is easily retained in place and easily removed when exhausted.

Yet further in accordance with the invention, a non-adhesive planar air freshener is provided comprising a flexible static cling sheet having an adhesive free first face to selectively removably cling to a glass surface, a second face, a first dimension, a second dimension and a footprint. A static cling free sheet is provided having a first face adhered to the static cling sheet and a second face, the static cling free sheet has a first dimension, a second dimension and a footprint. The static cling free sheet has a first dimension, a second dimension and footprint identical to the static cling sheet first dimension, second dimension and footprint. An adhesive sheet is provided having an adhesive first face, an adhesive second face, a first dimension smaller than the static cling sheet first dimension and a footprint smaller than the static cling first sheet, the adhesive sheet first face being adhered to the static cling free sheet second face. A planar fragrance member is provided having a first face, a second face, a first dimension equal to the adhesive sheet first dimension, a second dimension and a footprint. The fragrance member carries a fragrance adapted to emit a scent into a surrounding atmosphere, the fragrance member first face being fixed to the adhesive sheet second face. The fragrance member can have a printed design on the first face and the second face and can be selected from the group consisting of a fiberboard sheet, a cardboard sheet, and a paper sheet. The fragrance member emits increased fragrance when heated and emits decreased fragrance when cooled. The fragrance member is printed in a pattern including dark inks whereby the fragrance member performs the duty of distinguishing the air freshener as a decal and the duty of automatically variably activating the air freshener. Additionally, a metering sheet is provided having a first face, a second face, a first dimension, a second dimension and a footprint. The metering sheet first face is fixed to at least one of the static cling free sheet, the adhesive sheet and the fragrance member such that at least a portion of the metering sheet first face is in contact with the fragrance member second face. The metering sheet is adapted to allow passage of the scent at a selected rate.

In accordance with the invention, a non-adhesive planar air freshener is provided comprising a flexible static cling polymer layer having an adhesive free first face to selectively removably cling to a surface, a second face, a first dimension, a second dimension and a footprint. A graphic sheet is provided having a first face, adhered to the static cling polymer layer, and a second face. The graphic sheet has a first dimension, a second dimension and a footprint. The graphic sheet first dimension, a second dimension and footprint being substantially the same as the static cling polymer layer first dimension, second dimension and footprint. A fragrance member is provided having a first face, a second face, a first dimension equal to the graphic sheet first dimension, a second dimension and a footprint. The fragrance member carries a fragrance adapted to emit a scent into a surrounding atmosphere, the fragrance member first face being fixed to the graphic sheet second face. The fragrance member is adapted to emit the scent at a selected rate partially based upon temperature.

Yet still further in accordance with the invention, a removable non-adhesive planar air freshener is provided comprising a first planar member having an adhesive free static cling first face to selectively removably cling to a surface, a second face, a first planar dimension, a second planar dimension and a footprint. A planar display sheet is further provided having a first face, a second face and a footprint. The display sheet first face is permanently fixed to the first planar member second face and can bear a printed design. A planar fragrance member is also provided having a uniform thickness, a first face, a second face, a first planar dimension, a second planar dimension and a footprint. The fragrance member first face is in contact with the display sheet second face. The fragrance member is a body of cured liquid polymer and impregnated with a scent.

Yet further in accordance with the invention, a removable non-adhesive planar air freshener is provided comprising a planar polymer layer having an adhesive free static cling first face to selectively removably cling to a substantially flat surface, a second face, a first planar dimension, a second planar dimension and a footprint. A graphic display sheet is provided having a first face, adhered to the polymer layer, and a second face. The graphic sheet includes a first dimension, a second dimension and a footprint. The graphic sheet first dimension, second dimension and footprint are substantially the same as the polymer layer first dimension, second dimension and footprint. A planar fragrance member is also provided having a first face, a second face, a first planar dimension, a second planar dimension and a footprint. The fragrance member first face is permanently fixed to the graphic sheet second face. The fragrance member is an odor emitting polymer adapted to provide air freshening in a confined space.

These and other aspects of the present invention will become apparent to those skilled in the art from the following description taken in conjunction with the accompanying drawings.

### BRIEF DESCRIPTION OF THE DRAWINGS

FIG. 1 is a front view of an air freshener made in accordance with the present invention, the front side being the side adapted for application to an automobile windshield interior surface;

FIG. 2 is a back view of the air freshener of FIG. 1;

FIG. 3 is a side view of the air freshener of FIGS. 1 and 2 showing the thin profile of the air freshener;

FIG. 4 is a cross section of the air freshener taken along line A-A of FIG. 2;

FIG. 5 is an enlarged detail of the portion of the cross section of FIG. 4 marked B in FIG. 4;

FIG. 6 is an exploded view showing the individual elements used to construct the embodiment shown on FIGS. 1-5 and their interrelationship;

FIG. 7 is an exploded view showing the individual elements used to construct a second embodiment in accordance with the present invention;

FIG. 8 is a rear view of a third embodiment of an air freshener made in accordance with the description, the rear side being the side adapted for exposure to a confined space;

FIG. 9 is a side view of the air freshener of FIG. 8 showing the thin profile of the air freshener;

FIG. 10 is a cross section of the air freshener taken along line 10-10 of FIG. 8;

FIG. 11 is an enlarged detail of the portion of the cross section of FIG. 10 marked 11 in FIG. 10; and,

FIG. 12 is an exploded view showing the individual elements used to construct the embodiment shown in FIGS. 8-11 and their interrelationship.

### DETAILED DESCRIPTION

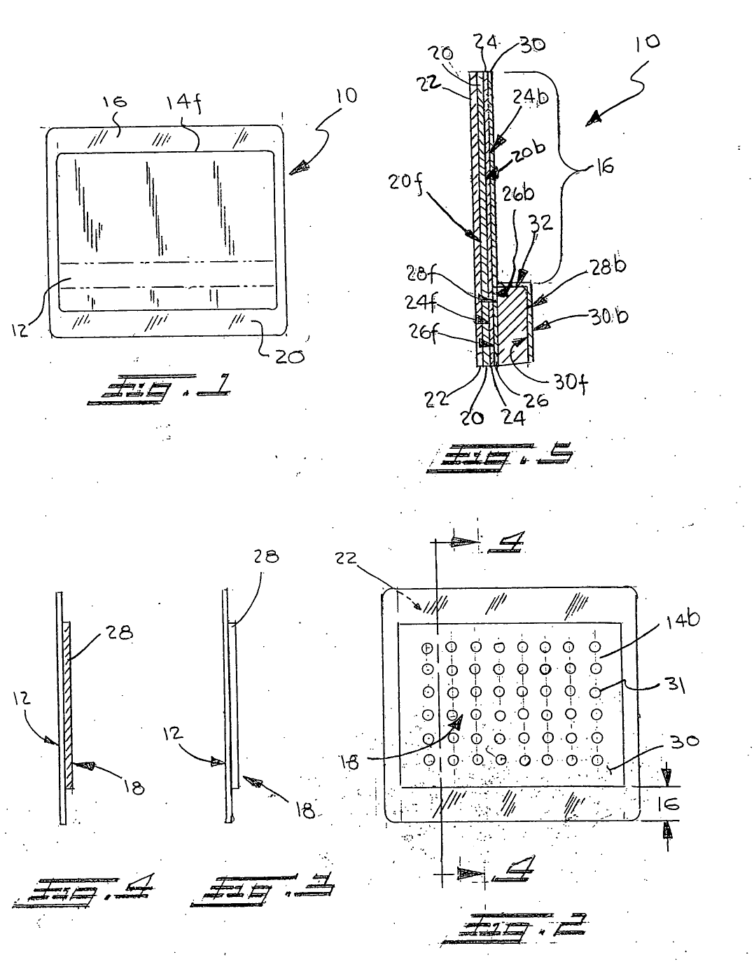

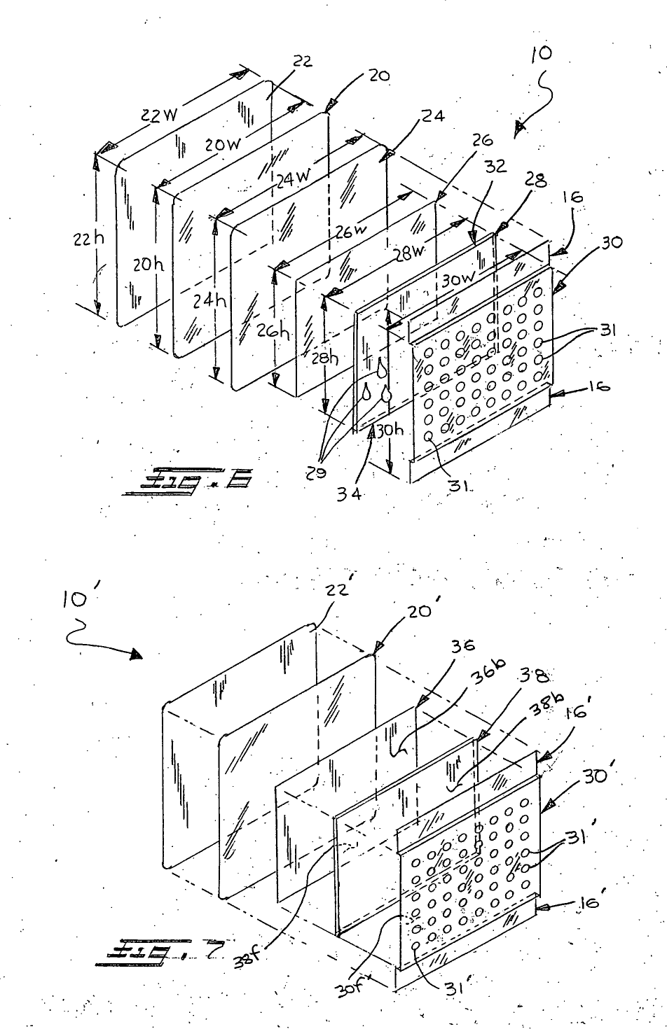

Referring now to the drawings wherein the showings are for the purposes of illustrating an embodiment of the invention and not for the purposes of limiting same, FIG. 1 shows an air freshener 10 in accordance with an embodiment of the invention. The front view or side 12 of the air freshener 10 is seen in FIG. 1. The front side 12 is the side that can be seen from the outside of an automobile when the air freshener is applied to the inside surface of the windshield of an automobile. The front side 12 comprises a central printed area 14f surrounded by a transparent margin 16. The central printed area 14f can be provided with a design, possibly including words and serial numbers, simulating a parking sticker or club membership decal of the type frequently seen on automobile windshields. The central area 14f can be surrounded by a transparent margin 16 which can appear to be transparent plastic. Of course, the margins 16 could be translucent or even opaque so long as the central printed area 14f and its design are visible at the front side 12.

Referring now to FIG. 2, a back view or side 18 of the air freshener 10 is shown. Some of the structural elements of the back side 18 are emphasized in FIG. 2 for purposes of clarity. In use, the back side 18 can have a resemblance similar to the front side 12. That is, a back face central printed area 14b is surrounded by the transparent margin 16. The back face central printed area 14b is preferably opaque with a printed legend thereon either identical to the printed legend on the front face central printed area or, as shown, different from the front face printed area 14f. Of course, the back face central printed area 14b could be left opaque and blank without departing from the spirit of the invention.

Thus, the appearance of the air freshener 10 from both the front view 12 and the back view 18 strongly resembles a parking or membership decal as is frequently seen on the inside of an automobile windshield.

The elements used to construct the air freshener 10 are seen in FIG. 6. A static cling or first sheet 20 is the frontmost element of the air freshener 10. A protective backing or cover 22 can be provided to protect the static cling sheet 20 from contaminants until installation is desired and/or between installations. The protective cover 22 can help to preserve the static cling properties of the static cling sheet 20. The static cling sheet 20 can be generally rectangular with rounded corners and include a width or first planar dimension 20 w and a height or second planar dimension 20 h. Along with a footprint 20A generally defined as the product of the width dimension 20 w and the height dimension 20 h (20 w×20 h). The static cling sheet 20 can be a uniformly thin sheet, typically 2 to 6 mils, and is selected to have static cling properties on its front or first face 20f. Certain films, such as certain vinyl films and certain polyvinyl chloride films are known to cling to glass surfaces without the need of an adhesive. The static cling characteristic of plastic film and sheets has been used in the past for products such as food wrap.

A barrier or static cling free sheet 24 is provided with an adhesive on its front or first face 24f (the face facing the static cling sheet 20), a width or first dimension 24 w and a height or second dimension 24 h. The width dimension 24 w and height dimension 24 h of the barrier sheet 24 can be identical to the width 20 w and height dimension 20h, respectively, of the static cling sheet 20. The barrier sheet 24 can be generally rectangular with round corners and have a footprint 24A identical to the footprint 20A of the static cling sheet 20. The barrier sheet 24 can be permanently fixed, by means of the adhesive on its front face 24f, to a back or second face 20b of the static cling sheet 20 in registry with the static cling sheet 20.

An adhesive sheet 26 is provided with an adhesive on both its front or first face 26f and its back or second face 26b. The adhesive sheet 26 has a width or first dimension 26 w slightly smaller than the width dimension 20 w of the static cling sheet 20 and a height or second dimension 26 h slightly smaller than the height dimension 20h of the static cling sheet 20. The adhesive sheet 26 can be fixed to the center of the back or second face 24b of barrier sheet 24. The adhesive sheet 26 can be generally rectangular with round or square corners and have a foot print 26A generally defined as the product of the width dimension 26 w and the height dimension 26 h (26 w×26 h).

A fragrance board or planar fragrance member 28 can be a thin fiberboard, paperboard or paper rectangle having a width or first planar dimension 28 w and a height or second planar dimension 28 h. The width dimension 28 w and the height dimension 28 h of the fragrance board 28 can be identical to the width 26 w and height dimensions 26 h, respectively, of the adhesive sheet 26. The fragrance board 28 can be generally rectangular with round or square comers and have a foot print 28A generally defined as the product of the width dimension 28 w and the height dimension 28 h (28 w×28 h). The fragrance board 28 is preferably 65 mils or less thick. The fragrance board 28 can be opaque and printed with a design on both its front or first face 28f, which forms the central printed area 14f, and its rear surface, which forms the back or second face 28b central printed area 14b. The fragrance board 28 is shown in FIG. 6 without printing for purposes of clarity. The fragrance board 28 can be porous. The fragrance board 28 carries a quantity of fragrance, shown in FIG. 6 schematically as fragrance drops 29. The fragrance 29 is applied as a liquid and is volatile giving off a scent when exposed to air. The fragrance 29 is absorbed into the substance of the fragrance board 28 relatively uniformly and will not be visible as drops 29.

A thin plastic metering sheet 30 is provided with adhesive on the front or first face 30f facing the fragrance board 28. The metering sheet is provided with a non-adhesive back or second face 30b for ease of handling and placement to a desired location. The metering sheet 30 can be rectangular with a width or first dimension 30 w identical to the width dimension 28 w of the fragrance board 28 and a height dimension exceeding the height dimension 28 h of the fragrance board 28 and (an applied height or second dimension 30 h) identical to the height dimension 20 h of the static cling sheet 20. The metering sheet 30 can be generally rectangular with round or square comers and have a foot print 30A generally defined as the product of the width dimension 30 w and the height dimension 30 h (30 w×30 h). The metering sheet 30 can be provided with a multiplicity of through holes 31. In the embodiment shown, the metering sheet 30 is provided with 48 holes arranged as six rows of eight holes each. The number and size of the holes 31 are selected to provide an appropriate release rate for the fragrance 29 from the fragrance board 28.

The static cling sheet 20, the barrier sheet 24, the adhesive sheet 26 and the metering sheet 30 can be all fabricated from thin transparent plastic film. Moreover, all of these films can be flexible. The fragrance board 28 can be fabricated from fiberboard, paperboard or paper depending upon the amount of and type of fragrance 29 to be carried in the product and the desired thickness. A larger amount of fragrance can be carried in a thicker board. A thinner paper fragrance board will be more flexible and can be used with concentrated fragrances which do not require much volume.

The barrier sheet 24 can be fabricated from a plastic film selected to be impervious to the adhesives used and to the fragrance carried by the fragrance board 28. It protects the vinyl cling sheet 20 from possible attack by the fragrance.

As shown in FIGS. 1 and 2, the fragrance board 28 is preferably printed on both sides 28f, 28b to resemble a parking or membership sticker. Paper, cardboard and fiberboard are easily printed. None of the other layers of the air freshener 10 needs to be printed. None of the other layers of the air freshener 10 need to be colored in any way.

The adhesive sheet 26 may be replaced by an adhesive layer (not shown) applied to a portion of the barrier sheet 24 or the fragrance board 28.

The barrier sheet 24 provides the advantage of protecting the static cling sheet 20 from attack by the adhesives used in other layers 26, 30 and from attack by the fragrance 29. If a fragrance 29 is selected which will not attack the static cling sheet 20, it may be possible to dispense with the barrier sheet 24. However, the barrier sheet 24 also masks the static cling sheet 20 from the interior of the automobile. This prevents the second face 20b of the static cling sheet 20 from drawing and holding dust and other dirt elements and having a dirty appearance.

As can be seen in FIG. 5, the metering sheet 30 lays against the barrier sheet 24 in the margin areas 16. The metering sheet 30 also lays against top and bottom edges 32, 34 of the fragrance board 28 and the back face 28b of the fragrance board 28. Because of this, the unapplied metering sheet 30 will have a height dimension (not illustrated) slightly greater than height dimension 20 h of the static cling sheet 20 so that its ‘as applied’ height dimension 30 h is equal to the height dimension 20 h of the static cling sheet 20 and barrier sheet 24.

A location for mounting the air freshener 10 is near the lower left corner of an automobile windshield. In this position, the air freshener 10 is exposed to sunlight on warm sunny days. The sunlight will have little effect on the transparent layers of the air freshener 10. The fragrance board 28 can be opaque and, preferably contains darkly colored areas. Sunlight will penetrate through a transparent automobile windshield and the transparent film layers of the air freshener 10 and illuminate and heat the fragrance member. The heated fragrance member will release fragrance into the automobile interior at an increased rate when compared to a cold air freshener as most volatile materials evaporate more quickly when heated. The air freshener is, thus, sunlight activated. On the other hand, in a northern winter, the air freshener will be ‘deactivated’ when a car is parked in a cold garage overnight. The air freshener will be reactivated when the driver turns on the heat, raising the temperature in the car interior. Thus, the air freshener 10 is automatically activated, at a variable rate, as needed only, extending its useful life.

With reference to FIG. 7, an air freshener formed in accordance with a second embodiment is illustrated. Like components are identified with like numerals including a primed (′) suffix and new components are identified with new numerals. As an alternative to the cardboard fragrance board 28 in an air freshener 10′, a thin rectangular block or odor abating member 38 of baking soda in a binder can be held in place by the metering sheet 30′ (see FIG. 7). A front or first face 38f of the odor abating member 38 can be in registry with an adhesive second face 36b of an adhesive or planar display sheet 36. A back or second face 38b of the odor abating member 38 can be in registry with the adhesive first face 30′f of the metering sheet 30′. The binder can be porous allowing the passage of air through the holes 31′, whereby odors in the air can be extracted and held in the block of baking soda. Similar to the fragrance board 28, the odor abating member 38 can be planar having a width or first dimension and a height or second dimension defining a footprint. This embodiment is particularly applicable to refrigerators. In this embodiment, the adhesive sheet 36 can be provided with a printed design on a front or first face 36f and function as a planar display sheet. The planar display sheet 36 can have a footprint similar to the footprint of the odor abating member 38.

Air fresheners 10,10′ can be packaged in an airtight retail package such as a rib and groove closure plastic bag or a blister pack (not shown). In this way, the fragrance is contained on the fragrance board 28 (and odor abating member 38 preserved) until the package is opened by the consumer and the air fresheners 10,10′ applied to the desired location. Air fresheners 10,10′ are used by the consumer by simply pressing it against a smooth glass or similar surface at the desired location. One appropriate location is the lower left corner of an automotive windshield. A glass surface in a refrigerator or a glass-like surface in a refrigerator is also appropriate. The static cling sheets 20, 20′ will cling tightly to a smooth clean glass surface even in freezing or hot temperatures. Air fresheners 10, 10′ will remain in place for a period of weeks or months and can be easily removed by peeling it away from the windshield with a finger or thumbnail. Because no adhesives are used on the cling face, no adhesive residue is left on the windshield or other glass surface. Air fresheners 10, 10′ can be applied to any window, mirror, shower stall door, or other glass-like surface where it will stay in place until removed.

The static cling properties of vinyls and polyvinyl chloride films of the class usable in this invention are not defeated by high humidity or moisture. A non-obtrusive, easily installed, non-messy and easily removed air freshener is thereby provided.

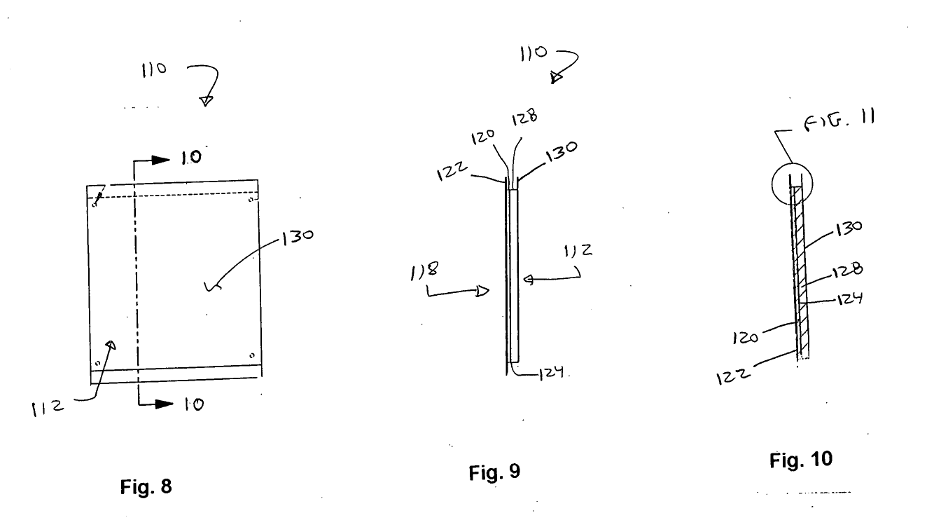

Referring now to FIGS. 8-12 wherein the showings are for the purposes of illustrating a third embodiment of the invention and not for the purposes of limiting same, FIG. 8 shows an air freshener 110 in accordance with the invention. A rear view or side 112 of the air freshener 110 is seen in FIG. 8. The rear side 112 is the side that can be seen from the inside of, for example, an automobile when the air freshener 110 is applied to the inside surface of the windshield of an automobile. The rear side 112 comprises a selectively removable clear cover 130. The clear cover 130 can be a clear acetate cover provided to protect a fragrance member 128 prior to installation.

The elements used to construct the air freshener 110 are seen in FIGS. 9-12. A static cling polymer layer 120 is provided for mounting to a substantially planar surface and is the front most element of the air freshener 110 (when in the installed position). A protective backing or cover 122 can be provided to protect the static cling polymer layer 120 from contaminants until installation is desired and/or between installations. The protective cover 122 can be an acetate cover for protecting the, for example, static cling properties of the static cling polymer layer 120. The static cling polymer layer 120 can be substantially rectangular and include a width or first planar dimension 120 w and a height or second planar dimension 120 h. Along with a footprint 120A substantially defined as the product of the width dimension 120 w and the height dimension 120 h (120 w×120 h). The static cling polymer layer 120 can be a uniformly thin layer, i.e., 60 mils thick, and is selected to have static cling properties on its front or first face 120f. Certain substances, such as certain KALENETM® POLYMERS manufactured by United Polymer Technologies are known to cling to surfaces without the need of an adhesive and can be used for polymer layer 120. The polymer layer 120 can be transparent or translucent, thereby allowing a graphic sheet to be visible therethrough.

barrier, display or graphic sheet layer 124 is provided with an adhesive on its front or first face 124f (the face facing a back face 120b of the static cling polymer layer 120), a width or first dimension 124 w and a height or second dimension 124 h. The width dimension 124 w and height dimension 124 h of the barrier sheet 124 can be identical to the width 120 w and height dimension 120 h, respectively, of the static cling polymer layer 120. The barrier sheet 124 can be substantially rectangular and have a footprint 124A identical to the footprint 120A of the static cling polymer layer 120. The barrier sheet 124 can be provided with a design on both faces 124f, 124b, possibly including words and serial numbers, simulating a parking sticker or club membership decal of the type frequently seen on automobile windshields.

The polymer layer 120 and the fragrance member 128 can be thin polymers of cured liquid butyl rubber. One such suitable substance is KALENETM®. Different varieties and compositions of KALENE products are described in U.S. patent publication 2003/0054311 and are incorporated in their entirety herein.

The fragrance member 128 can include a rectangular geometry having a width or first planar dimension 128 w and a height or second planar dimension 128 h. The width dimension 128 w and the height dimension 128 h of the fragrance member 128 can be identical to the width 124 w and height dimensions 124 h, respectively, of the graphic sheet 124. The fragrance member 128 can be substantially rectangular with round or square comers and have a foot print 128A substantially defined as the product of the width dimension 128 w and the height dimension 128 h (128 w×128 h). The fragrance member 128 can be, for example, about 150 mils thick. The fragrance member 128 can be transparent or translucent, thereby allowing the graphic sheet 124 to be visible therethrough. The fragrance member 128 can be a polymer, i.e., a liquid butyl rubber, impregnated with a scent or fragrance. The fragrance member 128 carries a quantity-of fragrance (not illustrated). The fragrance can be impregnated in the liquid butyl rubber prior to curing and can give off a scent when exposed to air. The fragrance is absorbed into the butyl rubber of the fragrance member 128 relatively uniformly and will not be visible. Thus, the appearance of the air freshener 110 from both the front view 112 and the back view 118 strongly resembles a parking or membership decal as is frequently seen on the inside of an automobile windshield or the inside of a locker.

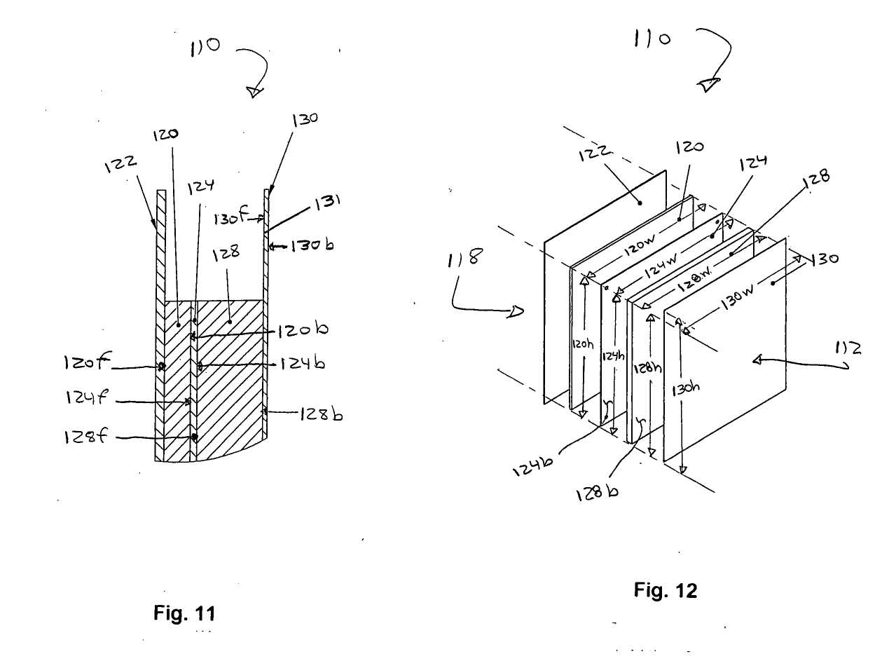

The thin plastic cover sheet 130 is provided with adhesive on the front or first face 130f facing the fragrance member 128. The cover sheet 130 can be provided with a non-adhesive back or second face 130b for ease of handling and placement to a desired location. The cover sheet 130 can be rectangular with a width or first dimension 130 w substantially the same as the width dimension 128 w of the fragrance member 128 and a height dimension 130 h greater than the height dimension 128 h of the fragrance member 128. The increased height 130 h of cover sheet 130 provides a tab 131 to facilitate removal of sheet 130 from fragrance member 128. The cover sheet 130 can be substantially rectangular and have a foot print 130A substantially defined as the product of the width dimension 130 w and the height dimension 130 h (130 w×130 h). The cover sheet 130 can be a clear acetate material. As can be seen in FIG. 11, the cover sheet 130 lays against the back face 128b of the fragrance member 128.

The static cling polymer layer 120, the barrier sheet 124, and the fragrance member 128 can be flexible. The fragrance member 128 can be fabricated from varying thicknesses of polymer depending upon the amount of and type of fragrance to be carried in the product and the desired application. A larger amount of fragrance can be carried in a thicker member. A thinner fragrance member will be lighter and can be used with concentrated fragrances which require relatively less volume.

The barrier sheet 124 can be fabricated from a plastic film or fiberboard selected to be impervious to the polymers used and to the fragrance carried by the fragrance member 128. The graphic sheet 124 can be printed on both sides 124f, 124b (not illustrated) to resemble a parking or membership sticker. Paper, cardboard and fiberboard are easily printed. None of the other layers of the air freshener 110 needs to be printed. Due to the translucent nature of the polymer layer 120 and fragrance member 128, the barrier sheet 124 can be viewed therethrough from either side.

A location for mounting the air freshener 110 is, for example, near the lower left comer of an automobile windshield. In this position, the air freshener 110 is exposed to sunlight on warm sunny days. As described above, the static cling polymer layer 120 and fragrance member 128 can be transparent or translucent thereby allowing sunlight therein. Sunlight will penetrate through a transparent automobile windshield and the polymer layer 120 of the air freshener 110 thereby illuminating and heating the fragrance member 128. The heated fragrance member 128 will release fragrance into the automobile interior at an increased rate when compared to a cold air freshener as most volatile materials evaporate more quickly when heated. The air freshener 110 can be thus, sunlight activated. On the other hand, in a northern winter, the air freshener will be “deactivated” when a car is parked in a cold garage overnight. The air freshener 110 can be subsequently “reactivated” when the driver turns on the heat, raising the temperature in the car's interior. Thus, the air freshener 110 is automatically activated, at a variable rate, as needed only, extending its useful life.

The fragrance member 128 can include an additive, i.e., color, which will change after a set time or duration of exposure to the air, or after a period of exposure to UV. The change in color, for example, can be indicative of the expiration of the fragrance member 128.

Air freshener 110 can be packaged in an air tight retail package such as a rib and groove closure plastic bag or a blister pack (not shown). In this way, the fragrance can be retained in the fragrance member 128 until the package is opened by the consumer and the air freshener 110 applied to the desired location. Air freshener 110 is used by the consumer by simply pressing it against a smooth glass or a substantially planar surface at the desired location. As discussed above, one appropriate location is the lower left corner of an automotive windshield. A locker door or other surface in a locker is also appropriate. The static cling sheet 120 will cling tightly to a substantially smooth surface even in freezing or hot temperatures. The static cling properties of KALENE® of the class usable in this invention are not defeated by high humidity or moisture, and are also chemical resistant. Air freshener 110 can remain in place for a period of weeks or months and can be easily removed by peeling it away from the mounting surface with a finger or thumbnail. Because no adhesives are used on the cling face, no adhesive residue is left on the windshield or other mounted surfaces. Thus, air freshener 110 can be applied to any window, mirror, locker door, or other substantially flat surface where it will stay in place until removed. A non-obtrusive, easily installed, non-messy and easily removed air freshener is thereby provided.

While considerable emphasis has been placed herein on the structure of the illustrated embodiments and the structural interrelationships between component parts of the embodiments, it will be appreciated that many changes in the embodiments herein illustrated and described can be made without departing from the principles of the invention. Accordingly, it is to be distinctly understood that the foregoing descriptive matter is to be interpreted merely as illustrative of embodiments and not as a limitation.

It is claimed:

1. A non-adhesive planar air freshener comprising:
a flexible static cling polymer layer having an adhesive free first face to selectively removably cling to a surface, a second face, a first dimension, a second dimension and a footprint;
a graphic sheet having a first face adhered to said static cling polymer layer and a second face, said graphic sheet having a first dimension, a second dimension and a footprint;
said graphic sheet first dimension, second dimension and footprint being substantially the same as said static cling polymer layer first dimension, second dimension and footprint;
a fragrance member having a first face, a second face, a first dimension equal to said graphic sheet first dimension, a second dimension and a footprint; said fragrance member impregnated with a fragrance and adapted to emit a scent into a surrounding atmosphere, said fragrance member first face being fixed to said graphic sheet second face; and,
said fragrance member being adapted to emit said scent at a selected rate partially based upon temperature.

2. The air freshener of claim 1, wherein said fragrance member comprises a cured liquid butyl rubber.

3. The air freshener of claim 1, wherein said graphic sheet is opaque.

4. The air freshener of claim 1, wherein said graphic sheet is printable on said first face and said second face.

5. The air freshener of claim 1, wherein said fragrance member is transparent.

6. The air freshener of claim 1, wherein said fragrance member is translucent and color changeable based on duration of exposure.

7. The air freshener of claim 1, wherein said static cling polymer layer is transparent.

8. The air freshener of claim 1, wherein said air freshener has a maximum thickness and said static cling polymer layer first dimension is at least ten times greater than said maximum thickness.

9. The air freshener of claim 8, wherein said static cling polymer layer second dimension is at least ten times greater than said maximum thickness.

10. The air freshener of claim 1, wherein said static cling polymer layer is translucent.

11. The air freshener of claim 10, wherein said fragrance member has a thickness and said fragrance member first dimension is substantially greater than said thickness.

12. The air freshener of claim 1, wherein said graphic sheet is dark in color and printed in a pattern whereby said graphic sheet performs the duty of distinguishing said air freshener as a decal.

13. The air freshener of claim 1, wherein said fragrance member emitting increased fragrance when heated and emitting decreased fragrance when cooled.

14. A removable, non-adhesive planar air freshener comprising:
a first planar member having an adhesive free static cling first face to selectively removably cling to a surface, a second face, a first planar dimension, a second planar dimension, and a footprint;
a planar display sheet having a first face, a second face and a footprint, said display sheet first face permanently fixed to said first planar member second face and bearing a printed design;
a planar fragrance member having a uniform thickness, a first face, a second face, a first planar dimension, a second planar dimension and a footprint; and,
said fragrance member first face being in contact with said display sheet second face.

15. The air freshener of claim 14, wherein said fragrance member is a body of cured liquid polymer.

16. The air freshener of claim 15, wherein said polymer is impregnated with a scent.

17. A removable non-adhesive planar air freshener comprising:
a planar polymer layer having an adhesive free static cling first face to selectively removably cling to a substantially flat surface, a second face, a first planar dimension, a second planar dimension and a footprint,
a graphic sheet having a first face adhered to said polymer layer and a second face, said graphic sheet having a first dimension, a second dimension and a footprint;
said graphic sheet first dimension, second dimension and footprint being substantially the same as said polymer layer first dimension, second dimension and footprint; and,
a planar fragrance member having a first face, a second face, a first planar dimension, a second planar dimension and a footprint, said fragrance member first face permanently fixed to said graphic sheet second face entirely within the footprint of said graphic sheet, said fragrance member being an odor emitting polymer providing air freshening in a confined space.

18. The air freshener of claim 17, wherein said fragrance member comprises a cured liquid butyl rubber.

19. The air freshener of claim 17, wherein said fragrance member is translucent.

20. The air freshener of claim 17, wherein said planar polymer layer is translucent.

21. A non-adhesive planar air freshener comprising:
a flexible static cling sheet having an adhesive free first face to selectively removably cling to a glass surface, a second face, a first dimension, a second dimension and a footprint;
a static cling free sheet having a first face adhered to said static cling sheet and a second face, said static cling free sheet having a first dimension, a second dimension and a footprint; said static cling free sheet first dimension, second dimension and footprint being identical to said static cling sheet first dimension, second dimension and footprint;
an adhesive sheet having an adhesive first face, an adhesive second face, a first dimension smaller than said static cling sheet first dimension and a footprint smaller than said static cling first sheet, said adhesive sheet first face being adhered to said static cling free sheet second face;
a planar fragrance member having a first face, a second face, a first dimension equal to said adhesive sheet first dimension, a second dimension and a footprint; said fragrance member opaque and carrying a fragrance adapted to emit a scent into a surrounding atmosphere, said fragrance member first face being fixed to said adhesive sheet second face;
said fragrance member having a printed design on said first face and said second face and is selected from the group consisting of a fiberboard sheet, a cardboard sheet, and a paper sheet;
said fragrance member emitting increased fragrance when heated and emitting decreased fragrance when cooled;
said fragrance member is printed in a pattern including dark inks whereby said fragrance member performs the duty of distinguishing said air freshener as a decal and the duty of automatically variably activating said air freshener; and,
a metering sheet having a first face, a second face, a first dimension, a second dimension and a footprint, said metering sheet first face being fixed to at least one of said static cling free sheet, said adhesive sheet and said fragrance member such that at least a portion of said metering sheet first face is in contact with said fragrance member second face, said metering sheet allowing passage of said scent therethrough at a selected rate.

22. The air freshener of claim 21, wherein said metering sheet has a multiplicity of holes allowing passage of said scent.

23. The air freshener of claim 21, wherein said static cling sheet is a vinyl plastic sheet.

24. The air freshener of claim 21, wherein said static cling sheet is a polyvinyl chloride plastic sheet.

25. The air freshener of claim 21, wherein said static cling sheet, said adhesive sheet and said metering sheet are transparent.

26. The air freshener of claim 21, wherein said air freshener has a maximum thickness and said static cling sheet first dimension is at least ten times greater than said maximum thickness.

27. The air freshener of claim 26, wherein said static cling sheet second dimension is at least ten times greater than said maximum thickness.

28. The air freshener of claim 21, wherein said planar fragrance member has a thickness and said fragrance member first dimension is substantially greater than said thickness.

29. The air freshener of claim 28, wherein said fragrance member first dimension is at least ten times said thickness.

30. The air freshener of claim 29, wherein said fragrance member first dimension and said fragrance member second dimension are both at least ten times said thickness.

31. A non-adhesive planar air freshener comprising:
a flexible static cling sheet having an adhesive free first face to selectively removably cling to a glass surface, a second face, a first dimension, a second dimension and a footprint;
an adhesive sheet having an adhesive first face, an adhesive second face, a first dimension smaller than said static cling sheet first dimension and a footprint smaller than said static cling first sheet, said adhesive sheet first face being adhered to said static cling sheet second face;
a substantially planar member having a first face, a second face, a first dimension equal to said adhesive sheet first dimension, a second dimension and a footprint; said planar member first face being fixed to said adhesive sheet second face;
said planar member is selected from the group consisting of a fragrance member and an odor abating member; and,
a metering sheet having a first face, a second face, a first dimension, a second dimension and a footprint, said metering sheet first face being fixed to at least one of said static cling sheet, said adhesive sheet and said planar member such that at least a portion of said metering sheet first face is in contact with said planar member second face, said metering sheet including a multiplicity of holes allowing passage of air therethrough at a selected rate.

32. The air freshener of claim 31, wherein said metering sheet is a thin plastic sheet; and, said fragrance member emitting increased fragrance when heated and emitting decreased fragrance when cooled.

33. A removable, non-adhesive planar air freshener comprising:
a first sheet having an adhesive free static cling first face to selectively removably cling to a glass surface, a second face, a first planar dimension, a second planar dimension and a footprint;
a planar adhesive sheet having a first face, a second face and a footprint, said adhesive sheet first face permanently fixed to said first sheet second face entirely within said first sheet footprint;
a thin opaque block member having a uniform thickness, a first face, a second face, a first planar dimension, a second planar dimension and a footprint,
said block member first face being in contact with said adhesive sheet second face;
said block member is selected from the group consisting of a fragrance member and an odor abating member; and,
a metering sheet having a first face in contact with said block member second face and having a second planar dimension larger than said block member second planar dimension, a portion of said metering sheet first face being permanently fixed to said first sheet second face, said metering sheet allowing passage of air therethrough at a selected rate.

34. The air freshener of claim 33, wherein said metering sheet is a thin plastic sheet having an array of holes therein; and, said fragrance member emitting increased fragrance when heated and emitting decreased fragrance when cooled.
